(19) United States
(12) Patent Application Publication
(10) Pub. No.: US 2010/0106784 A1
(43) Pub. Date: Apr. 29, 2010

(54) ELECTRONIC DEVICE WITH AUTOMATIC SOFTWARE UPDATE FUNCTION AND METHOD THEREOF

(75) Inventors: CHUAN-HONG WANG, Tu-Cheng (TW); HSIAO-CHUNG CHOU, Tu-Cheng (TW); LI-ZHANG HUANG, Tu-Cheng (TW); XIAO-GUANG LI, Shenzhen City (CN); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/469,649

(22) Filed: May 20, 2009

(30) Foreign Application Priority Data
Oct. 24, 2008 (CN) 200810305191.7

(51) Int. Cl. G06F 15/82

(52) U.S. Cl. 709/206

(57) ABSTRACT

An electronic device for automatically updating software and a method thereof are provided. The method includes steps of: reading an email; detecting whether the read mail should be used for updating the software of the electronic device, comprising: identifying whether the server ID number of the remote server, which sends the read email, matches one of the authorization numbers; detecting whether parameters of the read email are acceptable according to predetermined rules; detecting whether a file of an email content is a software file if the parameters of the read email are acceptable according to the predetermined rules; determining whether to update the software of the electronic device; acquiring the software file from the read email, storing the acquired software file in the storage unit, and running the acquired software file to update the software of the electronic device.

### BACKGROUND

1. Technical Field

The disclosure relates to an electronic device with automatic software update function and a method thereof.

2. Description of Related Art

In general, software must be updated regularly. However, the update process usually involves a user logging into a server through a website to download a new version of the software, then installing the new software. Although, the above method works, it is time-consuming.

Therefore, what is needed is an electronic device with automatic software update function and a method thereof.

### BRIEF DESCRIPTION OF THE DRAWINGS

FIG. 1 is a schematic diagram of a system, including an electronic device with automatic software update function which includes an email application with email receiving and accessing function, in accordance with an exemplary embodiment.

FIG. 2 is a block diagram of a hardware infrastructure of the electronic device of FIG. 1 in accordance with an exemplary embodiment.

FIG. 3 is a flowchart of a method for automatically updating software implemented by the electronic device of FIG. 2 in accordance with an exemplary embodiment.

### DETAILED DESCRIPTION

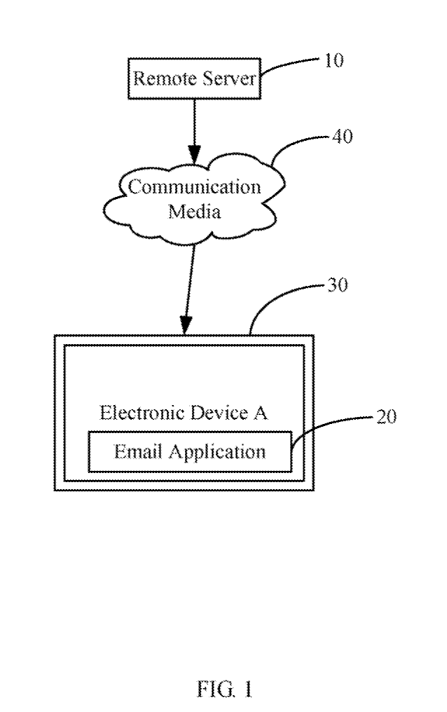

FIG. 1 is a schematic diagram of a system, including an electronic device with automatic software update function which includes an email application with email receiving and accessing function, in accordance with an exemplary embodiment. The system can include a plurality of remote servers 10, and a plurality of electronic devices 30. Each of the electronic devices 30 binds an email application 20, which has an email receiving and accessing function. In the exemplary embodiment, the disclosure only takes one remote server 10 and one electronic device 30 to describe the principles of the disclosure.

The remote server 10 is configured to send email to the email application 20 of the electronic devices 30 via a communication media 40, for example, a network (e.g., the Internet, a local network, a local area network, or a wireless network). The email content may include, but is not limited to, image information, text information, software file etc. In the exemplary embodiment, the remote server 10 sends an email, which includes a software file to the email application 20. The software file, which includes an identifier, a version number, and a release date, of the software, is to update or replace the corresponding software of the electronic device 30. The identifier, which can be a predetermined filename, or a predetermined suffix, and so on, indicates the software file.

The email application 20 is configured to receive and store emails sent by the remote server 10 via the communication media 40. The electronic device 30 is configured to log into the remote server 10 via the communication media 40 to read the received emails via the email application 20. The electronic device 30 has an automatic software update function.

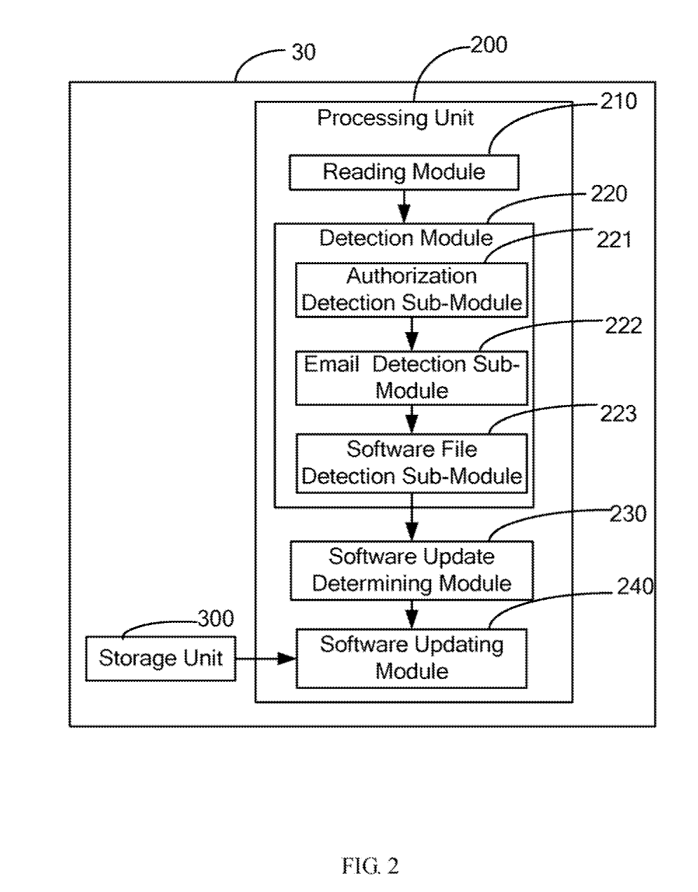

FIG. 2 is a block diagram of a hardware infrastructure of the electronic device 30 of FIG. 1 in accordance with an exemplary embodiment. The electronic device 30 includes a processing unit 200 and a storage unit 300. The storage unit 300 is configured to store the emails acquired by the electronic device 30, and a list of authorization numbers corresponding to remote servers authorized to provide updated software such as the remote server 10, whose server identification (ID) number corresponds to one of the authorization numbers on the list. The processing unit 200 includes a reading module 210, a detection module 220, a software update determining module 230, and a software updating module 240. The reading module 210 is configured to read emails from the email application 20.

The detection module 220 is configured to detect whether the read email should be used for updating the software of the electronic device 30. The detection module 220 further includes an authorization detection sub-module 221, an email detection sub-module 222, and a software file detection sub-module 223.

The authorization detection sub-module 221 identifies whether the server ID number of the remote server 10 is an authorization number. If the server ID number is not one of the authorization numbers, the processing unit 200 deals with the read email in a general manner without updating. In the exemplary embodiment, the general manner includes, but is not limited to, reading the email, replying to the email, forwarding the email, and so on. If the server ID number is an authorization number then the email detection sub-module 222 deals with the read email as detailed below.

The email detection sub-module 222 checks email from authorized servers to detect whether parameters of the read email are acceptable according to predetermined rules. The parameters can be, but are not limited to, an email subject, and email content, and so on. In the exemplary embodiment, the predetermined rules are that the email subject and/or email content of the read email include one or more predetermined keywords, and the content of the read email includes a special file or files. The email detection sub-module 222 detects whether the email subject and/or email content of the read email include one or more predetermined keywords, such as, “software updating,” “software updating of the electronic device,” and the content of the read email includes a special file or files. If the subjects and/or contents of the read email include the predetermined keywords, and the content of the read email includes a special file, the email detection module 222 determines that the parameters of the read email are acceptable according to the predetermined rules.

In other exemplary embodiment, the predetermined rules can be: the email subject and/or email content of the read email includes a verification code, and the content of the read email includes a special file or files. The verification code can be a predetermined code or an identification (ID) code of the electronic device 30. The email detection sub-module 222 detects whether the email subject and/or email content of the read email include the verification code, and the content of the read email includes a special file or files. If the email subject and/or email content of the read email include the verification code, and the content of the read email includes a special file or files, the email detection module 222 determines that the parameters of the read email are acceptable according to the predetermined rules.

The software file detection sub-module 223 is configured to detect whether the file of the email content is a software file if the parameters of the read email are acceptable according to the predetermined rules. In the exemplary embodiment, the software file detection sub-module 223 detects whether a filename of the file includes a predetermined suffix. If the filename of the file includes a predetermined suffix, the software file detection sub-module 223 determines that the file of the email content is a software file. In other embodiments, the software file detection sub-module 223 detects whether the filename of the file includes a predetermined keywords. If the filename of the file includes the predetermined keywords, the software file detection sub-module 223 determines that the file of the email content is a software file.

The software update determining module 230 is configured to determine whether to update the software of the electronic device if the file of the email content is a software file. In the exemplary embodiment, the software update determining module 230 acquires the version number and the release date of the software file which the read email includes, compares the acquired version number with the version number of the corresponding software of the electronic device 30, and identifies whether the acquired version number is higher than the version number of the corresponding software. If the acquired version number is higher than the version number of the corresponding software, the software update determining module 230 determines to update the software of the electronic device 30. Otherwise, the software update determining module 230 does not update the software of the electronic device 30.

The software updating module 240 is configured to acquire the software file from the read email if the acquired version number is higher than the version number of the corresponding software, store the acquired software file in the storage unit 300, and run the acquired software file to update the software of the electronic device 30. In the exemplary embodiment, if the acquired software file is a compressed file, the software updating module 240 downloads the software file to the storage unit 300, decompresses and runs the software file to update the software of the electronic device 30.

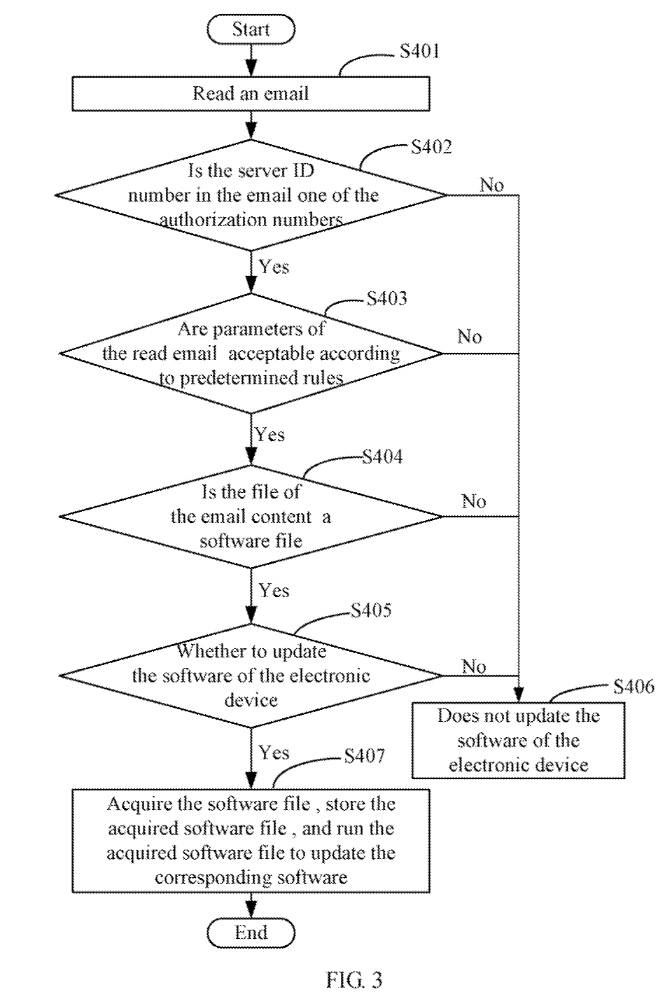

FIG. 3 is a flowchart of a method for automatically updating software implemented by the electronic device of FIG. 2 in accordance with an exemplary embodiment.

In step S401, the reading module 210 reads an email.

In step S402, the authorization detection sub-module 221 detects whether the server ID number of the remote server 10 included in the read email matches one of the authorization numbers, if no, go to step S406, if yes, go to step S403.

In step S403, the email detection sub-module 222 detects whether parameters of the read email are acceptable according to predetermined rules, if no, go to step S406, if yes, go to step S404.

In step S404, the software file detection sub-module 223 detects whether the file of the email content is a software file, if no, go to step S406, if yes, go to step S405.

In step S405, the software update determining module 230 determines whether to update the software of the electronic device, if no, go to step S406, if yes, go to step S407.

In step S406, the software updating module 240 does not update the software of the electronic device.

In step S407, the software updating module 240 acquires the software file from the read email, stores the acquired software file in the storage unit 300, and runs the acquired software file to update the corresponding software of the electronic device 30.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with an automatic software update function, wherein the electronic device accesses and receives emails from an email application, which communicates with a remote server via a communication media, and the remote server has an identification (ID) number, the electronic device comprising:
a storage unit capable of storing emails and a list of authorization numbers;
a processing unit comprising:
a reading module capable of reading an email;
a detection module capable of detecting whether the read mail should be used for updating a corresponding software of the electronic device, and comprising:
an authorization detection sub-module capable of identifying whether the server ID number of the remote server, which sends the read email, matches one of the authorization numbers;
an email detection sub-module capable of detecting whether parameters of the read email are acceptable according to predetermined rules if the server ID number matches one of the authorization numbers;
a software file detection sub-module capable of detecting whether a file included in the email content is a software file if the parameters of the read email are acceptable according to the predetermined rules;
a software update determining module capable of determining whether to update the corresponding software of the electronic device if the file included in the email content is a software file;
a software updating module capable of acquiring the software file from the read email if a version number of the software file is higher than a version number of the corresponding software of the electronic device, storing the acquired software file in the storage unit, and running the acquired software file to update the corresponding software of the electronic device.

2. The electronic device as in claim 1, wherein the email detection sub-module is configured for detecting whether an email subject and/or email content of the read email includes one or more predetermined keywords and the content of the read email includes a special file, to determine whether the parameters of the read email are acceptable according to the predetermined rules.

3. The electronic device as in claim 1, wherein the email detection sub-module is configured for detecting whether an email subject and/or email content of the read email includes a verification code and the content of the read email includes a special file, to determine whether the parameters of the read email are acceptable according to the predetermined rules.

4. The electronic device as in claim 4, wherein the verification code is a predetermined code or an identification code (ID) of the electronic device.

5. The electronic device as in claim 1, wherein the software file detection sub-module is capable of detecting whether a filename of the file comprises a predetermined suffix to determine whether the file is a software file.

6. The electronic device as in claim 1, wherein the software file detection sub-module is capable of detecting whether a filename of the file comprises predetermined keywords to determine whether the file is a software file.

7. A method for automatically updating software of an electronic device, wherein the electronic device accesses and receives emails from an email application, which communicates with a remote server via a communication media, and the remote server has an identification (ID) number, comprising:
reading an email;
detecting whether the read mail should be used for updating the software of the electronic device, comprising:
identifying whether the server ID number of the remote server, which sends the read email, matches one of authorization numbers;
detecting whether parameters of the read email are acceptable according to predetermined rules if the server ID number matches one of the authorization numbers;
detecting whether a file included in the read email content is a software file if the parameters of the read email are acceptable according to the predetermined rules;
determining whether to update the software of the electronic device if the file of the email content is a software file;
acquiring the software file from the read email if a version number of the software file is higher than a version number of a corresponding software of the electronic device, storing the acquired software file in the storage unit, and running the acquired software file to update the corresponding software of the electronic device.

8. The method as described in claim 7, wherein the parameter detecting step further comprising:
detecting whether an email subject and/or email content of the read email include one or more predetermined keywords, and the content of the read email includes a special file to determine whether the parameters of the read email are acceptable according to the predetermined rules.

9. The method as described in claim 7, wherein the parameter detecting step further comprising:
detecting whether an email subject and/or email content of the read email include a verification code, and the content of the read email includes a special file to determine whether the parameters of the read email are acceptable according to the predetermined rules.

10. The method as described in claim 7, wherein the verification code is a predetermined code or an identification code (ID) of the electronic device.

11. The method as described in claim 7, wherein the software file detecting step further comprising:
detecting whether a filename of the file comprises a predetermined suffix to determine whether the file is a software file.

12. The method as described in claim 7, wherein the software file detecting step further comprising:
detecting whether a filename of the file comprises predetermined keywords to determine whether the file is a software file.
